(19) United States
(12) Patent Application Publication
(10) Pub. No.: US 2021/0292234 A1
(43) Pub. Date: Sep. 23, 2021

(54) COMPOSITIONS FOR THE MANUFACTURE OF FLOORING ELEMENTS FOR INDOOR USE

(71) Applicant: Swisspearl Group AG, Niederurnen (CH)

(72) Inventor: Thomas ENDL, Vöcklabruck (AT)

(73) Assignee: Swisspearl Group AG, Niederurnen (CH)

(21) Appl. No.: 16/318,042

(22) PCT Filed: Jul. 14, 2017
(86) PCT No.: PCT/EP2017/067930

§ 371 Date: Jan. 15, 2019

(30) Foreign Application Priority Data
Jul. 15, 2016 (EP) 16179813.7

(51) Int. Cl. C04B 28/04; C04B 18/24; C04B 14/28; C04B 40/00; E04F 15/02; E04F 15/10

(52) U.S. Cl. CPC C04B 28/04; C04B 18/24; C04B 14/28; C04B 2111/60; E04F 15/02038; E04F 15/107; C04B 40/0042

(57) ABSTRACT

It is an object of the present invention to provide a composition for manufacturing an flooring element for indoor use comprising a cementitious binding material, a cellulosic fibre blend, wherein the cellulosic fibre blend comprises cellulosic fibres having a first degree of SR fineness and cellulosic fibres having a second degree of SR fineness, when measured according to ISO 5267-1, and wherein the first degree of SR fineness is in the range of from 5 to 45, preferably of from 20 to 40, and the second degree of SR fineness is in the range of from 45 to 80, preferably of from 50 to 70.

### TECHNICAL FIELD

The present invention relates to compositions suitable in the manufacture of flooring elements for indoor use, a process for the manufacture of said flooring elements for indoor uses, as well as to the use of said composition in such a process for the manufacture.

### PRIOR ART

In houses and other types of buildings, the flooring may be made from a vast array of possible materials. Traditionally, most flooring has been wood flooring such as plank or parquet. While even to this day, the look and feel of wood flooring is sought after, the wood flooring that is commercially available suffers from several disadvantages. On one hand, the wood flooring will have a heterogeneous appearance, since no two pieces of wood flooring are be identical, while on the other hand wood flooring suffers from dimensional shrinkage/expansion in response to changes in air humidity and/or temperature. This propensity for dimensional shrinkage/expansion makes the use of wood flooring impractical, since in the worst case the buildup of expansion tension can lead to significant damage to the wood flooring.

Another inherent drawback of wood flooring is that it constitutes a fire hazard. While it is possible to apply a fire retarding agent to wood flooring, such agents increase the cost of the wood flooring and can furthermore be problematic from a toxicological perspective. The same can be said about composite wood flooring that is based on MDF (medium density fiberboard) and HDF (high density fiberboard). While dimensional shrinkage is improved, these fiberboards release volatile organic components (VOCs) from the resin that is used as a binder material in the MDF and HDF flooring, which is exacerbated when used indoors where ventilation is reduced.

Polymer materials are also used for flooring and but have the problem of being inherently flammable and the drawback of elongating/deforming in response to a temperature rise, for example when sunlight shines directly on the flooring, and are rather soft (i.e. not hard) materials prone to scuffing and scratching.

Mineral flooring such as for example fiber cement does not suffer, or to a lesser extent, from the above-mentioned disadvantages, since in general mineral materials do not burn and do not display important dimensional shrinkage in response to changes in humidity or temperature. However, in addition to flammability and dimensional shrinkage, fiber cement needs to fulfill a vast range of mechanical properties when used in flooring applications in order to fully substitute existing flooring types.

Two important properties are strength and hardness. On one hand, the flooring made of fiber cement needs to be able to elastically spring back into its original shape after being deformed and on the other hand, the material needs to be hard enough to be able to be easily be cut into a desired final shape and size with high precision.

Finally, it is important to note that the manufacture of fiber cement can be costly and complex, which is why a less costly and less technically complex manufacturing are desirable.

Thus, it is desirable to provide alternatives to wood or plastic flooring, such as for example fiber cement compositions, that when processed to a flooring element, have a lesser propensity for dimensional shrinkage in response to a change of temperature, which are able to elastically spring back into the original shape after being deformed and which are hard enough to be able to be easily be cut into a desired final shape and size with high precision. Low fire hazard and the very low emission of VOCs to indoor air of such fiber cement compositions are further advantages.

### SUMMARY OF THE INVENTION

The above-mentioned problems have been overcome by the present invention which provides a composition for manufacturing flooring elements for indoor use which are essentially non-flammable, do not display significant dimensional shrinkage in response to a change in temperature, are resilient and capable of elastically springing back into their original shape when deformed in use as flooring, which can optionally manufactured without polymeric fibers, and which can be easily cut into a desired shape and size with high precision, especially when cut by machining.

It is an object of the present invention to provide a composition for manufacturing a flooring element for indoor use comprising a cementitious binding material, a cellulosic fibre blend, wherein the cellulosic fibre blend comprises cellulosic fibres having a first degree of SR fineness and cellulosic fibres having a second degree of SR fineness, when measured according to ISO 5267-1, and wherein the first degree of SR fineness is in the range of from 5 to 45, preferably of from 20 to 40, and the second degree of SR fineness is in the range of from 45 to 80, preferably of from 50 to 70.

It is further an object of the present invention to provide a flooring element or multilayer flooring element, comprising at least a structure made from a cured composition according to the above description, and wherein said structure is preferably a load-bearing layer.

It is further an object of the present invention to provide an interlocking flooring element for indoor use or multilayer interlocking flooring element for indoor use comprising at least a structure, a first interlocking structure and a second interlocking structure made from a cured composition according to the above description, and wherein said structure is preferably a load-bearing layer, and wherein the first and the second interlocking structures are made from a cured composition according to the above description, and wherein preferably the form of the first interlocking structure is essentially complementary to the form of the second interlocking structure, and wherein most preferably the load-bearing layer, the first interlocking structure and the second interlocking structure are integrally formed from one body of a cured composition according to the above description.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows the flow chart of the manufacturing process for the flooring element for indoor use, in which a scale for the cellulose (1) and a water tank (2) determine the amount of cellulose provided to the pulper and refiner (3), from which the formed cellulose pulp is directed to the cellulose pulp tanks (4, 5). From the cellulose pulp tanks (4, 5), cellulose pulp is dosed to the mixer II (10). From the cement slurry mixer I (9), a cement slurry is dosed to the mixer II (10). The cement slurry is prepared by dosing dry cement from the cement tank (6), water from the water tank (8), and filler from the filler tank (7) to the cement slurry mixer I (9) and mixing the dry cement, water and filler. In the mixer II (10), the cement slurry and the cellulose pulp are mixed and dosed to a horizontal mixer III (11), from where the composition for forming the flooring element is conveyed to the Hatschek machine (12) in which the unshaped wet green web (13) is formed and then shaped into a given shape in the stamp (14). Any wet green stamping waste (15) can be recycled into the horizontal mixer III (11) The wet green webs are then conveyed to a stack press (16) to be pressed and form the wet green sheets. The wet green sheets are stacked and subsequently allowed to cure in the curing chamber (17) to form flooring element blanks, after which the individual flooring element blanks are un-stacked (18) and conveyed to a drying apparatus (19), in which the individual flooring element blanks are further dried to desired moisture content. Following the drying, the flooring element blanks may be temporarily stored in a stock (20), and may then be finished into multilayer flooring element blanks in a finishing line (21) for example in the case of multilayer flooring elements. The thus formed flooring element or multilayer flooring element blanks are then formed into flooring elements or multilayer flooring elements by machining said blanks in a milling apparatus (22). The lines (15) and (23) indicate recirculation means that enable to recirculate stamp waste and water, respectively, into the horizontal mixer III (11) and the water tanks (2, 8).

FIG. 2 shows a part of a multi-layered interlocking flooring element for indoor use having an upper layer (24) and a load-bearing-layer (25), where a first interlocking structure is formed into a tongue (27) having a bulge (26) on the lower side of the tongue.

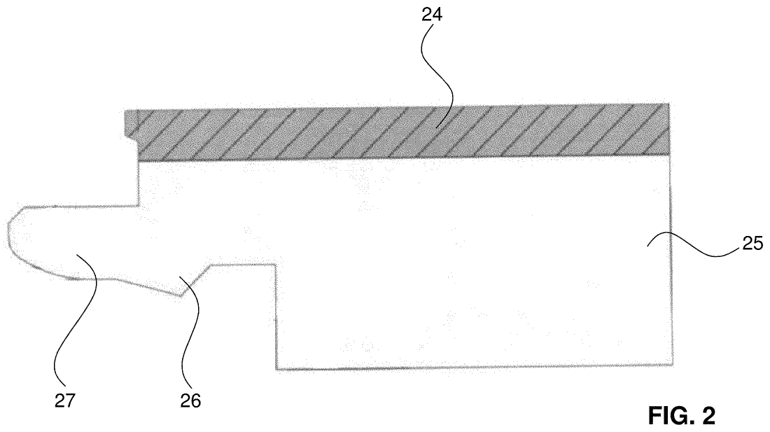

FIG. 3 a part of a multi-layered interlocking flooring element for indoor use having an upper layer (24) and a load-bearing-layer (25), where a second interlocking structure which is complementary to a first interlocking structure shown in FIG. 2, is formed into a groove (30) having a recess (31) on the lower side of the groove (30).

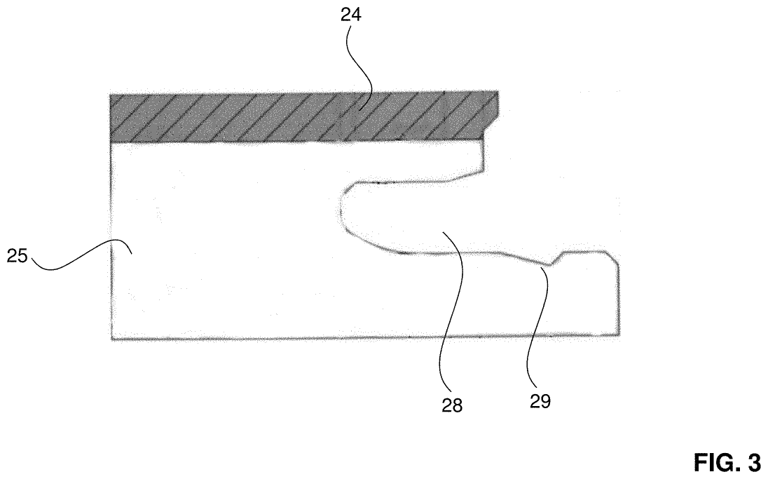

### DESCRIPTION OF PREFERRED EMBODIMENTS

It is an object of the present invention to provide a composition for manufacturing an flooring element for indoor use comprising a cementitious binding material, a cellulosic fibre blend, wherein the cellulosic fibre blend comprises cellulosic fibres having a first degree of SR fineness and cellulosic fibres having a second degree of SR fineness, when measured according to ISO 5267-1, and wherein the first degree of SR fineness is in the range of from 5 to 45, preferably of from 20 to 40, and the second degree of SR fineness is in the range of from 45 to 80, preferably of from 50 to 70. As an example, in the composition for manufacturing a flooring element for indoor use according to the present invention, the cellulosic fibre blend may comprise either cellulosic fibres having a first degree of SR fineness of about 15 and cellulosic fibres having a second degree of SR fineness of about 60, preferably in a weight ratio of 1:1, or cellulosic fibres having a first degree of SR fineness of about 35 and cellulosic fibres having a second degree of SR fineness of about 70, preferably in a weight ratio of 2:1.

In an embodiment of the composition for manufacturing an flooring element for indoor use according to the present invention, the cellulosic fibres are present of from 6 to 25 dry weight percent, preferably of from 10 to 25 dry weight percent; wherein the cellulosic fibres are preferably chosen from synthetic cellulosic fibres or natural cellulosic fibres, or combinations thereof; and/or wherein the cellulosic fibres are either virgin or recycled fibres, or combinations thereof. Examples of synthetic cellulosic fibres are rayon, viscose or surface-modified cellulosic fibres, whereas natural cellulosic fibres can be chosen from pulp, which can either be sourced from plant material such as wood (virgin wood pulp) or be sourced from paper waste streams such as recycled paper or cardboard (recycled wood pulp). Wood pulp can either be used as premanufactured slurry or as dried wood pulp sheets, blocks, chips or powder.

Besides serving the purpose of filtration and of process aid, the cellulosic fibre acts as reinforcing fibre. In the blank flooring element for indoor use made from the composition for manufacturing an flooring element for indoor use, the cellulosic fibres of the cellulosic fibre blend provide a good particle and interlayer bond and so a required hardness which in turn allows the blank flooring element to be cleanly machined with the required precision. Without this bonding and strength effect of the cellulosic fibres, the edges or surfaces formed after machining of the blank flooring element, display imperfections. This is not compatible with required aesthetics and can afterwards interfere with a flawless installing of the flooring elements.

In an embodiment of the composition for manufacturing an flooring element for indoor use according to the present invention, the cementitious binding material is present of from 60 to 90, preferably of from 70 to 75 dry weight percent, and wherein the cementitious binding material is a hydraulic binder material such as Portland cement, preferably according to EN 197-1 of the Type I, II, III, IV, and/or V. In essence, the cementitious binding material serves the purpose of binding fibrous material together such as for example the cellulosic fibres upon solidification, i.e. curing, of the cementitious binding material.

The cementitious binding material can be a hydraulic binder material such as cement. Suitable cements are Portland cement, blast-furnace Portland cement, trass cement, and others. Several types of Portland clinker cements can be used, but ordinary Portland cement is particularly preferred. In the case where the cementitious binding material is a hydraulic binder, solidification is brought about in a known manner by addition of water to the hydraulic binder of the composition for manufacturing a flooring element, to allow the hydraulic binder to cure and become adhesive due to a chemical hydration reaction between the hydraulic binder and water.

In an embodiment of the composition for manufacturing an flooring element for indoor use according to the present invention, the composition for manufacturing an flooring element for indoor use further comprises silica, filler, pigments, or additives, or combinations thereof.

If present, the filler which preferably is calcium carbonate, is present in an amount of less than 30, preferably of from 15 to 25 dry weight percent, and if present the silica is present of in an amount of less than 20, preferably less than 15 dry weight percent. The calcium carbonate can be ground or precipitated calcium carbonate, and can be sourced from limestone, chalkstone, chalk, or marble.

While the filler mostly serves as cost-reducing replacement for some of the hydraulic binder, the silica serves to control the density of the flooring element for indoor use and in particular raises the strength and interlayer bond of the flooring element for indoor use. This can have a favourable impact on strength, thermal and acoustic dampening properties of the flooring element for indoor use, and can thus be adjusted by controlling the amount of silica in the composition for manufacturing an flooring element for indoor use. The silica may furthermore act as filler of the pores of the cellulose and protects the cellulose from degradation due to the alkaline environment by mineralisation of the cellulose—so called “lumen loading”. The silica may be supplied in powder form or as slurry.

If present in the composition for manufacturing an flooring element for indoor use of the present invention, the silica is present in an amount of less than 20, preferably less than 15 dry weight percent, and/or has a particle size of about 50, or 100, to 200 nm, and/or is amorphous silica, preferably having a density at 20° C. of no more than 1000 kg/m3, and preferably of from 150 to 750 kg/m³.

If present in the composition for manufacturing an flooring element for indoor use of the present invention, the additive is chosen from wollastonite, mica to improve fire behaviour, strength and allow ease of production.

In an embodiment of the composition for manufacturing an flooring element for indoor use according to the present invention, the composition for manufacturing is essentially free of polymeric fibres, and/or wherein the weight ratio between the cellulosic fibres having at least a first degree of SR fineness and a second degree of SR fineness is of from 1:1 to 3:1. For instance, a composition for manufacturing a flooring element for indoor use according to the present invention may exhibit a weight ratio between the cellulosic fibres having at least a first degree of SR fineness and a second degree of SR fineness of 3:1, 2:1 or of 1:1.

In an embodiment of the composition for manufacturing an flooring element for indoor use according to the present invention, the cellulosic fibre blend further comprises cellulosic fibres having a third degree of SR fineness, wherein the third degree of SR fineness lies between the first and second degree of SR fineness, and preferably wherein the third degree of SR fineness is independently separated from the first and second degrees of SR fineness by about 5 to 25, or 10 to 15 degrees of SR fineness. In the case where the cellulosic fibre blend further comprises cellulosic fibres having a third degree of SR fineness, the weight ratio between the cellulosic fibres having at least a first degree of SR fineness, a second degree of SR fineness and a third degree of SR fineness is of from 1:1:1 to 3:1:3, or is of 3:1:3, 3:1:1, 1:1:3 or 1:1:1. As an example, in the composition for manufacturing an flooring element for indoor use according to the present invention, the cellulosic fibre blend may comprise cellulosic fibres having a first degree of SR fineness of about 15, cellulosic fibres having a second degree of SR fineness of about 60, and cellulosic fibres having a third degree of SR fineness of about 35, preferably in a weight ratio of about 1:1:1; i.e. the third degree is separated from the first degree of SR fineness by about 20 and separated from the second degree of SR fineness by about 25.

While in a preferred embodiment of the composition for manufacturing a flooring element for indoor use according to the present invention, the composition for manufacturing is essentially free of polymeric fibres, polymeric fibres may be nonetheless included in the composition for manufacturing an flooring element for indoor use of the present invention, in some cases. When included, the polymeric fibres serve the purpose of reinforcing fibres. Apart from certain mechanical properties, it can be advantageous that the polymeric fibres are made from a suitable polymer having a good resistance against alkaline hydrolytic degradation. Thus, suitable polymers for use in the polymeric fibres are polyolefins in general, and it has been found that fibres made from polyacrylonitrile (PAN), polypropylene (PP) or polyvinyl alcohol (PVA) can be used in composition for manufacturing a flooring element. In the case polymeric fibres are included the polymeric fibres are present of from 1.5 to 3, preferably of from 1.7 to 2.3 dry weight percent. If the amount of polymeric fibres is below the lower limit of 1 dry weight percent, the reinforcing effect achieved in the final flooring elements becomes insufficient, whereas adding more than the upper limit of 3 dry weight percent of polymeric fibres will result in complications of the Hatschek-type manufacturing process. The polymeric fibres are chosen from fibres having a tenacity of more than 8 cN/dtex or of between 8 and 25 cN/dtex, preferably of more than 10 cN/dtex or of between 10 and 25 cN/dtex and/or a young modulus of more than 200 cN/dtex or of between 200 cN/dtex and 500cN/dtex, preferably of more than 220 cN/dtex or of between 220 cN/dtex and 500cN/dtex; and preferably are made of polyacrylonitrile (PAN), polypropylene (PP) or polyvinyl alcohol (PVA), and preferably are made of polyvinyl alcohol (PVA). The polymeric fibres may further have an average linear mass density of 0.5 to 10 dtex and preferably of from 0.7 to 3 dtex and/or an average length of from 2, or 3, to 10 mm, and preferably of from 4 to 6 mm. In preferred embodiment, the polymeric fibre length distribution is bimodal, i.e. two different lengths of polymeric fibres are present in the composition for manufacturing a flooring element of the present invention, namely one having a shorter length and one having a longer length.

It is understood that in general, when using the term “made from any of the above-mentioned compositions” or “formed from any of the above-mentioned compositions” in conjunction with the term “flooring element”, “structure”, “interlocking structure”, “interlocking flooring element”, “interlocking structure”, or “load-bearing layer”, thus refers to the cured and/or dried slurry of the above-mentioned compositions.

It is further an object of the present invention to provide an flooring element for indoor use or multilayer flooring element for indoor use, comprising at least a structure made from a cured composition according to the above description, and wherein said structure is preferably a load-bearing structure/layer.

The flooring element for indoor use, multilayer flooring element for indoor use, interlocking flooring element for indoor use or multilayer interlocking flooring element for indoor use can be formed from a composition for manufacturing an flooring element for indoor use according to the above description through known processes for manufacturing fiberboard such as the Hatschek process, both in the air-cured version and the steam-cured version or the flow on process, to the extent that such a process yields a blank structure, or blank flooring element, to be used in the manufacture of an flooring element for indoor use, multilayer flooring element for indoor use, interlocking flooring element for indoor use or multilayer interlocking flooring element for indoor use.

The blank flooring element thus obtained is then further machined according to the process of the present invention to yield either a machined structure that is then incorporated into a more complex flooring element such as a multilayer flooring element for indoor use, interlocking flooring element for indoor use or multilayer interlocking flooring element for indoor use, or to yield a flooring element itself, respectively. In the case of a more complex flooring element, the blank flooring element thus obtained is incorporated into the more complex flooring element first and is only subsequently machined. It is understood that the term “machining” also includes an optional step of preliminary sanding the blank flooring element for calibration before effectively machining, i.e. sanding and/or milling, the blank flooring element into a desired type of flooring element.

In an embodiment of the flooring element or multilayer flooring element according to the present invention, the structure made from a cured composition according to the above description is further obtained by machining, and in particular milling, a blank flooring element made from a cured composition according to the above description.

An flooring element for indoor use according to the present invention may thus be formed essentially integrally from the composition for manufacturing a flooring element of the present invention, and is preferably machined, and in particular milled, to the desired shape. Alternatively, a load-bearing layer may be formed from the composition for manufacturing a flooring element of the present invention and incorporated into a more complex flooring elements, such as for example a multilayer flooring element. Also in this case, the load-bearing layer is preferably machined, and in particular milled, to the desired shape together with the additional layer comprised in the multilayer flooring element.

It is further an object of the present invention to provide an interlocking flooring element for indoor use or multilayer interlocking flooring element for indoor use comprising at least a structure, a first interlocking structure and a second interlocking structure made from a cured composition according to the above description, and wherein said structure is preferably a load-bearing layer, and wherein the first and the second interlocking structures are made from a cured composition according to the above description, and wherein preferably the form of the first interlocking structure is essentially complementary to the form of the second interlocking structure, and wherein most preferably the load-bearing layer, the first interlocking structure and the second interlocking structure are integrally formed from one body of a cured composition according to the above description. The first and second interlocking structures may be arranged on opposite sides of the interlocking flooring element for indoor use or multilayer interlocking flooring element for indoor use such as to join adjacent interlocking flooring element for indoor uses by joining the first interlocking structure of an interlocking flooring element for indoor use with the second interlocking structure of an adjacent interlocking flooring element for indoor use. For example, a first interlocking structure and a second interlocking structure can be a first shoulder and cheek and a second shoulder and cheek capable of forming a lap joint when the two or more interlocking flooring elements are installed side by side, or can be a first tongue structure and a second groove structure capable of forming a tongue and groove joint when the two or more interlocking flooring elements are installed side by side.

In an embodiment of the flooring element for indoor use or the interlocking flooring element for indoor use according to the present invention, the flooring element or interlocking flooring element is essentially integrally formed from a composition for manufacturing a flooring element described above, and is preferably machined, and in particular milled, to the desired shape.

In an embodiment of the flooring element for indoor use or the interlocking flooring element for indoor use according to the present invention, the flooring element for indoor use or interlocking flooring element for indoor use is a multilayer flooring element for indoor use or interlocking multilayer flooring element for indoor use in which at least a load-bearing layer is formed from a composition for manufacturing a flooring element described above.

In an embodiment of the flooring element for indoor use or interlocking flooring element for indoor use according to the present invention, the flooring element or interlocking flooring element is a multilayered flooring element or interlocking flooring element comprising a load-bearing layer at least partially made from a composition for manufacturing a flooring element described above, and optionally a top layer, bottom layer, where the top layer may for example be a decorative layer, a wear-resistant layer or a watertight layer and the bottom layer may for example be provided with fastening elements such as for example adhesive strips or preformed locking means designed to lock onto a underlying ground structure, and where in the case of the interlocking flooring element, the first and second interlocking structures are formed from a composition for manufacturing a flooring element described above, and are preferably machined, and in particular milled, to the desired shape, and where most preferably at least the first and second interlocking structures and the load-bearing layer are formed from one body of from a composition for manufacturing a flooring element described above.

In an embodiment of the multilayered interlocking flooring element for indoor use, the first and second interlocking structures are formed into a tongue having a bulge on one side of the tongue and a groove having a recess on the corresponding side of the groove, respectively, such that when adjacent multilayered interlocking flooring elements are joined during assembly of a flooring, the bulge of the tongue of a first interlocking flooring element is fitted into recess of the groove of an adjacent interlocking flooring element. In order to assemble the flooring, two adjoining multilayered interlocking flooring elements are forced laterally against each other such that the tongue and groove snap together by elastically deforming for a moment. The fitting of the bulge of the tongue into the recess of the groove allows the lateral locking of two adjoining multilayered interlocking flooring elements. By using the composition for manufacturing a flooring element described above, it becomes possible to provide a material that can be easily machined, but which also has the elastic properties for the above-described assembly in which the tongue and groove snap together by elastically deforming.

In an embodiment of the multilayered interlocking flooring element for indoor use, the first and second interlocking structures are formed into a tongue having a bulge on the lower side of the tongue and a groove having a recess on the lower side of the groove, respectively, such that when adjacent multilayered interlocking flooring elements are joined during assembly of a flooring, the bulge of the tongue of a first interlocking flooring element is fitted into the recess of the groove of an adjacent interlocking flooring element.

The flooring element for indoor use, multilayer flooring element for indoor use, interlocking flooring element for indoor use or multilayer interlocking flooring element for indoor use according to the present invention may have any form suitable to form a flooring, and the form may for example be that of a tile or a plank, and the flooring element for indoor use, multilayer flooring element for indoor use, interlocking flooring element for indoor use or multilayer interlocking flooring element for indoor use may optionally display pre-formed perforations that allow to fasten the flooring element, for example nail, screw or bolt to the underlying ground structure.

In an embodiment of the multilayered flooring element for indoor use or interlocking flooring element according to the present invention, the multilayered flooring element or multilayered interlocking flooring element comprises a polymer top layer and a load-bearing middle layer at least partially formed from a composition for manufacturing a flooring element described above, and/or has a thickness of from 2 to 20 mm.

In an embodiment of the interlocking flooring element or multilayer interlocking flooring element according to the present invention, the first interlocking structure and the second interlocking structure is obtained by machining, and in particular milling, a blank flooring element or multilayer blank flooring element comprising a cured composition according to the above description, wherein preferably the first and second interlocking structures are formed into a tongue having a bulge on one side of the tongue and a groove having a complementary recess on the corresponding side of the groove, respectively.

It is further an object of the present invention to provide a process for manufacturing a flooring element for indoor use or interlocking flooring element for indoor use, comprising the steps of

a. combining a liquid with a composition according to the above description and optionally silica, filler, pigments, additives, or any combination thereof, to form a slurry,

b. forming the slurry into a web such to form a wet green web,

c. pressing the wet green web to form a wet green sheet,

d. removing the liquid from the wet green sheet to form a blank flooring element,

e. forming the blank flooring element into the flooring element for indoor use or interlocking flooring element for indoor use,

wherein the flooring element for indoor use or interlocking flooring element for indoor use is formed from the blank flooring element by machining said blank flooring element such as to form a flooring element for indoor use or interlocking multilayer flooring element for indoor use, said interlocking flooring element for indoor use comprising at least a first interlocking structure and at least a second interlocking structure, and wherein preferably the form of the first interlocking structure is essentially complementary to the form of the second interlocking structure and/or preferably the first interlocking structure and the second interlocking structure are integrally formed from one body of a cured composition according to the above description.

In the process for manufacturing a flooring element or interlocking flooring element of the present invention made from the above-mentioned composition, the steps a. to d. correspond in essence, but are not limited to, the Hatschek process, which is well-known to the person skilled in the art of manufacturing fiber cement panels or cement board. A schematic representation of the Hatschek process is depicted in the drawings section in more detail for illustrative purposes. While the Hatscheck process allows for some degree of control with respect to the shape of the solid blank flooring element, the means for controlling the shape of the solid blank flooring element are however insufficient to achieve the degree of shaping precision required in flooring application, and in any case are unsuited to form interlocking structures of an interlocking flooring element. Therefore, the solid blank flooring elements must be shaped through more precise forming methods.

In the process for manufacturing an flooring element for indoor use or interlocking flooring element for indoor use of the present invention made from the above-mentioned composition, the flooring element for indoor use is formed from the blank flooring element that is yielded after removing the liquid from the wet green sheet, i.e. after curing and/or drying of the wet green sheet, by machining said solid blank flooring element into the desired shape. This step may be performed in-line or on-site in the manufacturing facility, or alternatively blank flooring elements may be stored and then transported to a machining or milling facility to be machined or milled into the desired shape.

In an embodiment of the process for manufacturing an flooring element for indoor use or interlocking flooring element for indoor use, in step d., the liquid from the cured wet green sheet is removed, e.g. by curing and/or subsequently drying, such as to form a blank flooring element preferably having a moisture content of from 1.5 to 9 w/w % or more preferably of 3 to 7 w/w %.

In an embodiment of the process for manufacturing an flooring element for indoor use or interlocking flooring element for indoor use, in step c., the wet green web is pressed to form a wet green sheet at a maximum pressure of from 150 bar (15 MPa) to 400 bar (40 MPa), preferably for at least 30 seconds if a wet green web is pressed alone, or for at least 5 minutes if a large stack of 30 to 200 green webs is jointly pressed.

It is further an object of the present invention to provide a process for manufacturing a multilayer flooring element for indoor use or interlocking multilayer flooring element for indoor use comprising a load-bearing layer at least partially made from a cured composition according to the above description, comprising the steps of

a. combining a liquid with a composition according to the above description and optionally silica, filler, pigments, additives, or any combination thereof, to form a slurry,

b. forming the slurry into a web such to form a wet green web,

c. pressing the wet green web to form a wet green sheet,

d. removing the liquid from the wet green sheet to form a solid blank flooring element,

e. applying one or more layers to the solid blank flooring element such as to form a multilayer blank flooring element,

f. forming the multilayer blank flooring element into the multilayer flooring element for indoor use or interlocking multilayer flooring element for indoor use comprising a load-bearing layer at least partially made from a cured composition according to the above description,

wherein the multilayer flooring element or interlocking multilayer flooring element is formed from the multilayer blank flooring element by machining said multilayer blank flooring element such as to form a multilayer flooring element, or interlocking multilayer flooring element, said interlocking multilayer flooring element comprising at least a first interlocking structure and at least a second interlocking structure, and wherein preferably the form of the first interlocking structure is essentially complementary to the form of the second interlocking structure and/or preferably the first and second interlocking structures and the load-bearing layer are formed from one body of a cured composition according to the above description.

In an embodiment of the process for manufacturing a multilayer flooring element for indoor use or interlocking multilayer flooring element for indoor use, in step c., the wet green web is pressed to form a wet green sheet at a maximum pressure of 150 bar (15 MPa) to 350 bar (35 MPa).

In an embodiment of the process for manufacturing a multilayer flooring element for indoor use or interlocking multilayer flooring element for indoor use, in step d., the liquid from the wet green sheet is removed by first curing the wet green sheet and subsequently evaporating residual water such as to preferably form a blank flooring element having a moisture content of from 1.5 w/w % to 9 w/w %, more preferably from 3 w/w % to 7 w/w %.

In an embodiment of the process for manufacturing a multilayer flooring element for indoor use or interlocking multilayer flooring element for indoor use, in step e., applying one or more layers to the solid blank flooring element such as to form a multilayer blank flooring element can be carried out through different methods, such as for example, but not limited to, calendaring, spray-coating, laminating or roller coating, gluing and such.

It is further an object of the present invention to provide a use of a composition according to the above description in the manufacture of a flooring element, interlocking multilayer flooring element, multilayer flooring element or interlocking multilayer flooring element.

### EXAMPLES

A first set of compositions for the manufacturing a flooring element comprising 70% dry weight of the cement CEM I 42.5 R, 10% dry weight of cellulosic fiber and 20% dry weight of limestone were prepared. The compositions then were made into test samples. A second set of compositions for the manufacturing a flooring element comprising 70% dry weight of the cement CEM I 42.5 R, 15% dry weight of cellulosic fiber and 15% dry weight of limestone were prepared. The compositions then were made into test samples.

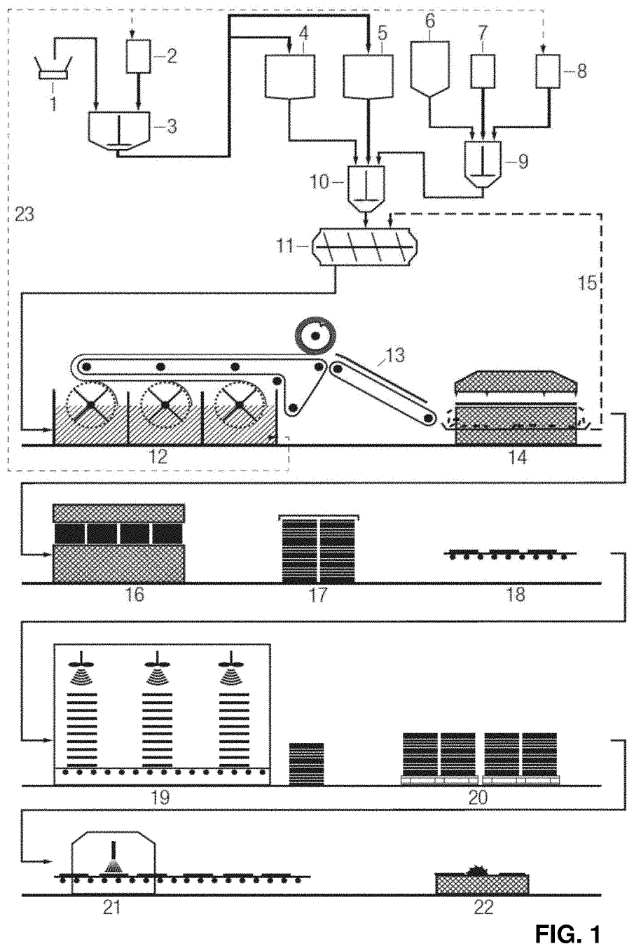

Compositions for the manufacturing a flooring elements were provided as specified in Table 1 and were processed according to the Hatschek-type process depicted in FIG. 1 to be formed into testing blank flooring elements for which modulus at rupture at break, modulus of rupture at elastic limit, long-term stability of tenacity, and climatic behavior for indoor use were recorded. In examples 1 to 5, the effect of including a cellulosic fibres having a sole degree of SR fineness was compared to the case where a cellulosic fiber blend having two degrees of SR fineness was included. In examples 6 to 7, the effect of including a cellulosic fibre blend having two degrees of SR fineness was compared to the case where a cellulosic fiber blend having three degrees of SR fineness was included.

As can be seen from Examples 1, 2 and 3, the higher the degree of SR fineness of the cellulosic fibres is, the lower the long-term stability of tenacity of the flooring, the better the climatic behavior and the higher the modulus of rupture at elastic limit. Thus, in order to achieve composition that exhibits good long-term stability, as well as good modulus of rupture at elastic limit, the overall amount of cellulosic fibre is split into an amount of cellulosic fiber having a lower degree of SR fineness and an amount of cellulosic fiber having a higher degree of SR fineness, as shown in Example 4 and 5. To further increase the long-term stability of the composition, the amount of cellulosic fibers having a degree of SR fineness below 40 was doubled as shown in Example 6 and 7. Using the compositions according to Examples 6 and 7 yielded testing blank flooring elements having a high modulus of rupture at break and at elastic limit and having long-term stability of tenacity and climatic behavior for indoor use that is excellent. While Example 6 is more complex from the point of view of the cellulosic fibers by including three degrees of SR fineness, it is more economical to manufacture flooring element for indoor uses including the composition according to Example 6 since in general, cellulosic fibers having a lower degree of SR fineness are less costly than cellulosic fibers having higher degree of SR fineness. Using the composition according to Examples 8 with increased overall cellulose content yielded testing blank flooring elements having the same high values in a high modulus of rupture at break and at elastic limit and long-term stability of tenacity. Only the indoors climatic behavior is lessened due to the rather high cellulose content, when compared to Examples 6 and 7. Comparative Example 9 shows that compositions for the manufacturing a flooring element comprising 70% dry weight of the cement CEM I 42.5 R, 4% dry weight of cellulosic fiber and 26% dry weight of limestone, i.e. with a dry weight of cellulosic fiber below 6%, are inferior in terms of modulus, long-term stability of tenacity and climatic behavior when compared to compositions where the dry weight of cellulosic fiber is above 6%.

TABLE 1

| EXAMPLES | 1 | 2 | 3 | 4 | 5 | 6 | 7 | 8 | 9 |
|---|---|---|---|---|---|---|---|---|---|
| Composition [dry W/W %]: | | | | | | | | | |
| Cement CEM I 42.5 R | 70 | 70 | 70 | 70 | 70 | 70 | 70 | 70 | 70 |
| Cellulose fiber 15° SR | 10 | | | | 5 | | 5 | | |
| Cellulose fiber 35° SR | | 10 | | 5 | | 10 | 5 | 10 | 2 |
| Cellulose fiber 60° SR | | | | 5 | 5 | 5 | 5 | 10 | 2 |
| Cellulose fiber 70° SR | | | 10 | | | | | | |
| Limestone | 20 | 20 | 20 | 20 | 20 | 15 | 15 | 10 | 26 |
| Manufacturing parameter | | | | | | | | | |
| Thickness [mm] | 6 | 6 | 6 | 6 | 6 | 6 | 6 | 6 | 6 |
| Processing at Hatschek Line | − | + | ++ | ++ | + | ++ | ++ | + | − |
| Pressure on the green web | 25 | 25 | 25 | 20 | 20 | 20 | 20 | 20 | 20 |
| [MPa] | | | | | | | | | |
| Performance (values measured | | | | | | | | | |
| in dry state in production | | | | | | | | | |
| direction) | | | | | | | | | |
| Modulus of rupture at break | 42 | 46 | 45 | 44 | 42 | 48 | 49 | 50 | 30 |
| [MPa] | | | | | | | | | |
| Modulus of rupture at elastic | 14 | 27 | 38 | 35 | 31 | 42 | 43 | 46 | 8 |
| limit [MPa] | | | | | | | | | |
| Longterm stability of tenacity | ++ | + | − | + | ++ | ++ | ++ | ++ | + |
| Climatic behaviour for indoor | − | + | ++ | ++ | ++ | ++ | ++ | + | + |
| use | | | | | | | | | |

Evaluation
++ good
+ suitable
− poor
−− not suitable

### LIST OF REFERENCE SIGNS

1 . . . scale for the cellulose

2 . . . water tank

3 . . . pulper and refiner

4 . . . cellulose pulp tank

5 . . . cellulose pulp tank

6 . . . cement tank

7 . . . filler tank

8 . . . water tank

9 . . . mixer I

10 . . . mixer II

11 . . . horizontal mixer III

12 . . . Hatschek machine

13 . . . wet green web

14 . . . stamp

15 . . . stamping waste

16 . . . stack press

17 . . . curing chamber

18 . . . blanks are un-stacked

19 . . . drying apparatus

20 . . . stock

21 . . . finishing line

22 . . . milling apparatus

23 . . . recirculation

24 . . . top layer

25 . . . load-bearing layer

26 . . . bulge

27 . . . tongue

28 . . . groove

29 . . . recess

1. A composition for manufacturing an flooring element for indoor use comprising
a cementitious binding material, and
a cellulosic fibre blend,
wherein the cellulosic fibre blend comprises cellulosic fibres having a first degree of SR fineness and cellulosic fibres having a second degree of SR fineness, when measured according to ISO 5267-1, and
wherein the first degree of SR fineness is in the range of from 5 to 45.

2. The composition according to claim 1, wherein the cellulosic fibres are present of from 6 to 25 dry weight percent.

3. The composition according to claim 1,
wherein the cementitious binding material is present of from 60 to 90 and
wherein the cementitious binding material is a hydraulic binder material.

4. The composition according to claim 1, wherein the composition optionally comprises silica, filler, pigments, or additives, or combinations thereof, and, if present, the filler, is calcium carbonate and present in an amount of less than 30, and, if present, the silica is present in an amount of less than 20.

5. The composition according to claim 1, wherein it is essentially free of polymeric fibres, and/or wherein the weight ratio between the cellulosic fibres having at least a first degree of SR fineness and a second degree of SR fineness is of from 1:1 to 3:1.

6. The composition according to claim 1,
wherein the cellulosic fibre blend further comprises cellulosic fibres having a third degree of SR fineness, and
wherein the third degree of SR fineness lies between the first and second degree of SR fineness.

7. A flooring element for indoor use or multilayer flooring element for indoor use, comprising at least a structure made from a cured composition according to claim 1, and wherein said structure is a load-bearing layer.

8. The flooring element for indoor use or multilayer flooring element for indoor use according to claim 7, wherein the structure is obtained by machining a blank flooring element made from the cured composition.

9. An interlocking flooring element for indoor use or multilayer interlocking flooring element for indoor use comprising at least:
a structure,
a first interlocking structure, and
a second interlocking structure,
wherein said structure is a load-bearing layer,
wherein the first and the second interlocking structures are made from a cured composition according to claim 1, and
wherein the form of the first interlocking structure is essentially complementary to the form of the second interlocking structure.

10. The interlocking flooring element for indoor use or multilayer interlocking flooring element for indoor use according to claim 9,
wherein the structure, the first interlocking structure and the second interlocking structure are obtained by machining a multilayer blank flooring element comprising the cured composition, and
wherein the first and second interlocking structures are formed into a tongue having a bulge on one side of the tongue and a groove having a complementary recess on the corresponding side of the groove, respectively.

11. A process for manufacturing an flooring element for indoor use or interlocking flooring element for indoor use, comprising the steps of
a. combining a liquid with a composition according to claim 1 and optionally silica, filler, pigments, additives, or combinations thereof, to form a slurry,
b. forming the slurry into a web such to form a wet green web,
c. pressing the wet green web to form a wet green sheet,
d. removing the liquid from the wet green sheet to form a blank flooring element,
and
e. forming the blank flooring element into the flooring element or interlocking flooring element,
wherein the flooring element for indoor use or interlocking flooring element for indoor use is formed from the blank flooring element by machining said blank flooring element such as to form an flooring element for indoor use or interlocking multilayer flooring element for indoor use, said interlocking multilayer flooring element for indoor use comprising at least a first interlocking structure and at least a second interlocking structure, and
wherein the form of the first interlocking structure is essentially complementary to the form of the second interlocking structure.

12. A process for manufacturing a multilayer flooring element for indoor use or interlocking multilayer flooring element for indoor use comprising a load-bearing layer at least partially made from a cured composition according to claim 1, comprising the steps of
a. combining a liquid with the composition and optionally silica, filler, pigments, additives, or combinations thereof, to form a slurry,
b. forming the slurry into a web such to form a wet green web,
c. pressing the wet green web to form a wet green sheet,
d. removing the liquid from the wet green sheet to form a solid blank flooring element,
e. applying one or more layers to the solid blank flooring element such as to form a multilayer blank flooring element, and
f. forming the multilayer blank flooring element into the multilayer flooring element or interlocking multilayer flooring element comprising a load-bearing layer at least partially made from the cured composition,
wherein the multilayer flooring element for indoor use or interlocking multilayer flooring element for indoor use is formed from the multilayer blank flooring element by machining said multilayer blank flooring element such as to form a multilayer flooring element for indoor use, or interlocking multilayer flooring element for indoor use, said interlocking multilayer flooring element for indoor use comprising at least a first interlocking structure and at least a second interlocking structure, and
wherein the form of the first interlocking structure is essentially complementary to the form of the second interlocking structure.

13. The process according to claim 11, wherein the wet green web is pressed to form a wet green sheet at a maximum pressure of 150 bar (15 MPa) to 350 bar (35 MPa).

14. The process according to claim 11, wherein in step d., the liquid from the wet green sheet is removed by first curing the wet green sheet and subsequently evaporating residual water such as to form a blank flooring element having a moisture content of from 1.5 w/w % to 9 w/w %, more preferably from 3 w/w % to 7 w/w %.

15. The composition according to claim 1, wherein the cellulosic fibre blend comprises cellulosic fibres having a first degree of SR fineness and cellulosic fibres having a second degree of SR fineness, when measured according to ISO 5267-1, and wherein the first degree of SR fineness is in the range of from 20 to 40, and the second degree of SR fineness is in the range of from 50 to 70.

16. The composition according to claim 1, wherein the cellulosic fibres are present of from 10 to 25 dry weight percent.

17. The composition according to claim 1, wherein the cellulosic fibres are chosen from synthetic cellulosic fibres or natural cellulosic fibres, or combinations thereof.

18. The composition according to claim 1, wherein the cellulosic fibres are virgin or recycled fibres, or combinations thereof.

19. The composition according to claim 1, wherein the cementitious binding material is present of from 70 to 75 dry weight percent, and wherein the cementitious binding material is a hydraulic binder material.

20. The composition according to claim 4, wherein the filler, if present, is calcium carbonate and present in an amount of from 15 to 25 dry weight percent, and the silica, if present, is present in an amount of less than 15 dry weight percent.

21. The composition according to claim 6, wherein the third degree of SR fineness is independently separated from the first and second degrees of SR fineness by about 5 to 25 degrees of SR fineness.

22. The composition according to claim 6, wherein the third degree of SR fineness is independently separated from the first and second degrees of SR fineness by about 10 to 15 degrees of SR fineness.

23. The interlocking flooring element for indoor use or multilayer interlocking flooring element for indoor use according to claim 10, wherein the load-bearing layer, the first interlocking structure and the second interlocking structure are integrally formed from one body of the cured composition.

24. The process for manufacturing an flooring element for indoor use or interlocking flooring element for indoor use according claim 11, wherein the first interlocking structure and the second interlocking structure are integrally formed from one body of the cured composition.

25. The process for manufacturing a multilayer flooring element for indoor use or interlocking multilayer flooring element for indoor use according to claim 12, wherein the first and second interlocking structures and the load-bearing layer are formed from one body of the cured composition.

26. The process according to claim 12, wherein the wet green web is pressed to form a wet green sheet at a maximum pressure of 150 bar (15 MPa) to 350 bar (35 MPa).

27. The process according to claim 12, wherein in step d, the liquid from the wet green sheet is removed by first curing the wet green sheet and subsequently evaporating residual water such as to form a blank flooring element having a moisture content of from 1.5 w/w % to 9 w/w %, more preferably from 3 w/w % to 7 w/w %.
